(19) United States
(12) Patent Application Publication
(10) Pub. No.: US 2022/0101132 A1
(43) Pub. Date: Mar. 31, 2022

(54) EVALUATING THE RELEVANCE OF POTENTIAL INPUT SIGNALS TO AN ARTIFICIAL NEURAL NETWORK

(71) Applicant: F-Enterprises GmbH, Anzing (DE)

(72) Inventors: Eduard Weinwurm, Vienna (AT); Jürgen Firsching, Anzing (DE)

(21) Appl. No.: 17/485,956

(22) Filed: Sep. 27, 2021

Related U.S. Application Data
(60) Provisional application No. 63/198,035, filed on Sep. 25, 2020.

(51) Int. Cl. G06N 3/08; G06N 3/063; G06K 9/62

(52) U.S. Cl. CPC G06N 3/08; G06N 3/063; G06K 9/6262; G06K 9/6228; G06K 9/6215

(57) ABSTRACT

Method and apparatus for training an artificial neural network circuit. In some embodiments, a set of possible inputs to the artificial neural network is identified. A first similarity measure between each of the possible inputs and a known output relevant to a task for which the artificial neural network is to be trained is generated. A second similarity measure is subsequently generated based on the first similarity measure. A set of relevant inputs from the set of possible inputs is selected based on the second similarity measure, and the set of relevant inputs is used to train the artificial neural network. The first and second similarity measures may be generated using a cosine similarity function based on individual inputs from the set of possible inputs. A sorting function can be used based on magnitude of a combined similarity function to select those relevant inputs above a selected threshold.

### RELATED APPLICATION

The present application makes a claim of domestic priority to U.S. Provisional Patent Application No. 63/198,035 filed Sep. 25, 2020, the contents of which are hereby incorporated by reference.

### BACKGROUND

Artificial neural networks, also sometimes referred to as machine learning systems, neural networks (nets) or artificial intelligence (AI) systems, are computer-based systems that attempt to mimic the operation of biological neural networks such as found in higher complexity animal brains. Neural networks can be used in a variety of applications including, but not limited to, image and speech recognition, language translation, social media filtering, medical diagnosis, gaming, trend and cyclic forecasting, and so on.

Neural networks are trained to perform certain computational and analysis tasks without being programmed with specific, task-based rules. A typical neural network includes a collection of connected units or nodes, which can be thought of as loosely modeling neurons in a biological brain. Each node (artificial neuron) transmits signals to other nodes as output values, which usually take the form of real numbers. The output values are provided with a magnitude that is computed by some function that combines one or more input values presented to that node.

A weight value may be assigned to each node, with the weight value being adjusted up or down during a training interval to increase or decrease the strength of the output signal at the associated node (e.g., the magnitude of the output value). In some cases, a threshold may be applied to each node such that outputs are only passed to downstream nodes if the magnitude of a given upstream node exceeds the threshold. As with the weights, the thresholds can be adaptively adjusted during training.

While neural networks have been found useful in many applications, one persistent limitation relates to the amount of resources that can be required to train a network to obtain satisfactory results. A polynomial growth function generally describes the backpropagation running time necessary to classify input signals as being useful during the training operation. This growth function can be a fifth order polynomial, or even higher (e.g., ˜O(n⁵), where n is the number of nodes). Thus, doubling the number of available input signals (e.g., 2×) can require 32 times (e.g., 2⁵) more computational resources to train the network. Increasing the number of inputs by a larger number, such as 100×, would correspondingly require on the order of around 10 billion (10⁹) additional resources, and so on.

This polynomial constraint can become unwieldy once the number of available inputs exceeds some reasonably small threshold. For this reason, neural networks are not easy to efficiently implement for exceptionally large data sets, such as those having millions or more possible data set inputs.

### SUMMARY

Various embodiments of the present disclosure are directed to a method and apparatus for training and operating an artificial neural network.

In some embodiments, a set of possible inputs to the artificial neural network is identified. A first similarity measure between each of the possible inputs and a known output relevant to a task for which the artificial neural network is to be trained is generated. A second similarity measure is subsequently generated based on the first similarity measure. A set of relevant inputs from the set of possible inputs is selected based on the second similarity measure, and the set of relevant inputs is used to train the artificial neural network. The first and second similarity measures may be generated using a cosine similarity function based on individual inputs from the set of possible inputs. A sorting function can be used based on magnitude of a combined similarity function to select those relevant inputs above a selected threshold.

These and other features and advantages of various embodiments can be understood from a review of the following detailed description in conjunction with the accompanying drawings.

### BRIEF DESCRIPTION OF DRAWINGS

FIG. 1 provides a functional block representation of a simplified artificial neural network constructed and operated in accordance with various embodiments.

FIG. 2A is a schematic depiction of the neural network from FIG. 1 in accordance with some embodiments.

FIG. 2B illustrates a generic node from FIG. 2A.

FIG. 3 shows another neural network system that incorporates a neural network such as depicted in FIGS. 1-2 in conjunction with a training front end constructed and operated in accordance with various embodiments to train the neural network using a limited number of relevant inputs.

FIG. 4 depicts a training set of data used by the training front end from FIG. 3 in some embodiments.

FIG. 5 is a flow chart for a training routine illustrative of steps carried out by the training front end in accordance with some embodiments.

FIG. 6 shows some aspects of the training front end in some embodiments.

FIG. 7 shows additional aspects of the training front end in further embodiments.

FIG. 8 is a table of similarity measures (functions) that can be utilized by the training front end in some embodiments.

FIG. 9 is a graphical representation of a sorting function carried out by the front end in some embodiments.

FIG. 10 is a functional block representation of the training front end in greater detail.

### DETAILED DESCRIPTION

Various embodiments of the present disclosure are generally directed to an apparatus and method for training and operating an artificial neural network. A training front end module (logic circuit) is provided which generates various similarity measures based on a large set of available inputs for the neural network. The similarity measures are used to select a significantly smaller set of relevant inputs from among the available inputs. The relevant inputs are thereafter used to train and operate the neural network.

The various embodiments reduce the need for the network to detect and mute irrelevant input signals by directing nodes to important input signals. This allows the system to predict the relevance of each given signal in terms of the task for which the network is being trained. As a result, a smaller node count and shorter training time may be achievable while obtaining higher network output performance by the trained network. The system further allows newly discovered signals of high relevance to be quickly identified and incorporated into the system.

The similarity measures that are used to select the set of relevant inputs may be based on a cosine similarity function, although this is merely illustrative and is not required as other forms of similarity functions can be used as desired. The similarity measures that are used to select the set of relevant inputs can be, in turn, based on combinations of other similarity measures of same or different type.

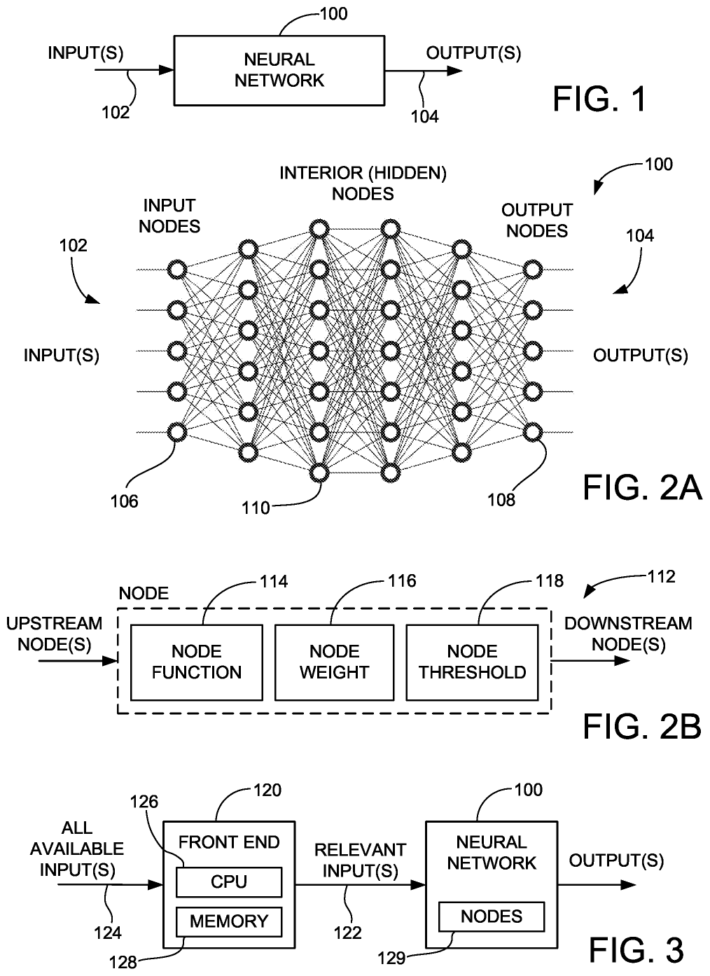

These and other features and advantages of various embodiments can be understood beginning with a review of FIG. 1, which provides a simplified functional block representation of an artificial neural network 100. Inputs are supplied to the network 100 via input signal paths 102. The network 100 operates upon the inputs to provide outputs which are supplied via output signal paths 104. The network 100 is trained as described below to provide useful and accurate outputs based on the presented inputs.

For reference, the network 100, as well as other aspects of the system described below, can be realized in any suitable manner using computer-based elements, such as one or more computers, workstations, networks of devices, etc. The system can further be realized using one or more programmable processors that utilize programming instructions stored in a memory, hardware circuits, gate arrays, specially configured application specific integrated circuits (ASICs), etc.

FIGS. 2A and 2B provides schematic representations of aspects of the neural network 100 from FIG. 1 in some embodiments. These simplified figures are provided merely for purposes of illustration and are not limiting. As shown by FIG. 2A, the network 100 includes a series of input nodes 106. Each input node 106 is configured to receive a different one of the inputs from the input signal lines 102. The network 100 further includes a series of output nodes 108, with each output node transmitting a different one of the outputs via the output signal lines 104. The respective input and output nodes 106, 108 are also sometimes referred to as “edge nodes” or “edges,” since these nodes are provided at the edges of the network.

FIG. 2A shows the network to have the same number of input nodes 106 as output nodes 108 (e.g., five nodes each), but this is merely for clarity of illustration. In practice, any respective numbers of input and output nodes can be used, and these numbers may be significantly different in many cases.

FIG. 2A further shows a number of interior nodes 110. The interior nodes, also sometimes referred to as hidden nodes, are interconnected in a cascaded fashion between the input nodes 106 and the output nodes 108. Each interior node 110 receives inputs from a group of upstream nodes, and in turn outputs values to a set of downstream nodes. Any desired number, sets and arrangements of the interior nodes 110 can be provided as desired to provide an internal array of nodes that interconnect the input and output nodes. The interconnection, configuration and operation of the interior nodes 110 serve to enable the network 100 to transform the input data at nodes 106 into useful output data at nodes 108.

Each node 106, 108, 110 can be thought of as an artificial neuron in the network 100, as represented by a generic node 112 in FIG. 2B. As noted above, the generic node 112 receives node inputs from one or more upstream nodes (or signal paths), and in turn outputs a node output that is forwarded to one or more downstream nodes (or signal paths). It is contemplated that the respective node inputs and node outputs will be expressed as real numbers, such as multi-bit digital representations of values over a selected range.

The node 112 performs a transformational operation upon the input signal(s) to generate the corresponding output signal(s). To this end, the node 112 can include a node function block 114, a node weight block 116 and a node threshold block 118. While it is contemplated that each node in the network will have all three (3) of these respective capabilities, this is not necessarily required.

The node function block 114 applies a selected node function to combine the input signals in some defined relation to generate a result. In the case of a single input signal to the node 112, the node function may be a simple pass-through operation. In the case of multiple input signals, the node function can combine the input signals to the node 112 using any desired function including but not limited to addition, subtraction, exclusive-or (XOR), exclusive-and (XAND), inversion, multiplication, division, higher order functions, etc. The network 100 can be configured such that substantially all of the nodes 112 apply the same node function, or different node functions can be assigned to different nodes.

The node weight block 116 operates, when used, to apply a weight to the output generated by the node function block 114. This may be a normalized scalar multiplier value, such as from 0 to 1. Generally, a higher weight value means that the output from the node will have a greater (e.g., more significant) effect upon remaining portions of the network, while a lower weight value means that the output from the node will have a lower (e.g., less significant) effect on remaining portions of the network.

The node threshold block 118 operates, when used, to apply a threshold to the weighted output generated by the operation of the node function block 114 and the node weight block 116. In some cases, the node threshold block 118 may operate as a high pass filter so that the output value generated by the node has to have a selected minimum magnitude before the output value is passed to the downstream nodes. In other cases, the node threshold block 118 may operate as a low pass filter (or a band pass filter) so that the output value generated by the node has to be below a selected maximum magnitude, or within a predetermined range, before the output value is passed to the downstream nodes.

FIG. 3 depicts the neural network 100 from FIGS. 1 and 2A-2B in combination with a front end module 120 constructed and operated in accordance with various embodiments of the present disclosure. The front end module 122, also sometimes referred to as a training front end or a front end engine, is specially configured to operate during a training phase for the neural network 100 to select a set of relevant inputs (via signal paths 122) that are useful for the network out of a much larger set of available inputs (via signal paths 124). Once the relevant inputs are selected, these are used to train, and thereafter operate, the network.

Once the network 100 is fully trained and configured, the module 120 is not necessarily required and can be removed from the system. However, in some embodiments, the module 120 can continue to be used to monitor the performance of the network 100 and, as required, make further adjustments to implement further improvements to the operation of the network.

As shown in FIG. 3, the front end module 120 can include one or more programmable processors (central processing units, CPUs) 126 and one or more memory locations 128. Hardware processing circuitry can be used in combination with or in lieu of the programmable processor(s) 126, such as but not limited to an FPGA, an ASIC, an SOC (system on chip), gate logic circuitry, etc. If one or more programmable processors is used, the memory 128 can be used to store program instructions executed thereby, as well as control information as described below. The neural network 100 includes a number of input, intermediate and output nodes 129 as well as associated circuitry as required.

Before discussing the operation of the module 120 in greater detail, some further background discussion regarding neural networks such as 100 may be helpful. It will be appreciated that the neural network 100 can be trained to perform substantially any suitable task. Such tasks can include, but are not limited to, image recognition, speech recognition, language translation, social media filtering, medical diagnosis, gaming, trend and cyclic forecasting, etc.

It follows that the specific task carried out by the neural network 100 is not germane to the present discussion, since the module 120 is well adapted to enable the network to carry out any of these or substantially any other desired task. Nevertheless, for purposes of providing a concrete example, it will be contemplated in the present discussion that the network 100 has been trained to predict a weather forecast for a selected city, such as Berlin, Germany. The weather will be for a selected future date, such as the following day (e.g., “tomorrow's forecast”). Thus, the network 100 is capable, on each particular day, to generate an accurate forecast of the weather that will occur in Berlin on the next day.

Using this example, the outputs 104 in FIG. 1 may provide one or more characteristics that are useful to such a forecast. These outputs can take any desired form, such as expected high temperature, expected low temperature, barometric pressure, predicted humidity, chances of precipitation, and so on, for the selected day.

The inputs 102 in FIG. 1 that are used to provide this selected forecast will be characterized as relevant inputs and can take any number of available forms such as (for example), the temperature or other weather related parameters from other locations geographically proximate Berlin, or from Berlin itself, averages of such parameters over a selected period of time, and so on.

At this point it will be recognized that the network 100 is trained as a forecasting tool based on a time sequence; hence, for a given target date T, different parameters may be taken from other times prior to this date as part of the relevant inputs 104. For example, the temperature in London on day T−2 (e.g., two days prior), or the barometric pressure in Grenada on day T−3 (e.g., three days prior), may be found to be relevant factors. On the other hand, the temperature in Berlin on day T−1 (e.g., the previous day), or the humidity in New York City at substantially any given time (e.g., T−1 to T−X), may be found to have little or no relevance at all with respect to accurately predicting the weather for the target date T.

From this simple example, it can be seen that the number of possible available inputs to the network is essentially limitless. Not only can the inputs be weather related parameters from other locations, but the inputs can also be combinations of these parameters, such as the daily high temperature over the preceding week, the rate of change in morning temperatures, precipitation, the amount of cloud coverage, wind speed and/or direction, etc. Non-weather based data, such as beach attendance or social media keyword trends, may also be found to be possibly relevant inputs to predicting the future weather in Berlin by the network.

The module 120 evaluates these and other possible, available inputs and reduces this down to those inputs that have the greatest effect on generating an accurate forecast. The module 120 thereafter configures the network 100 so that only these most relevant inputs are used to train and operate the network.

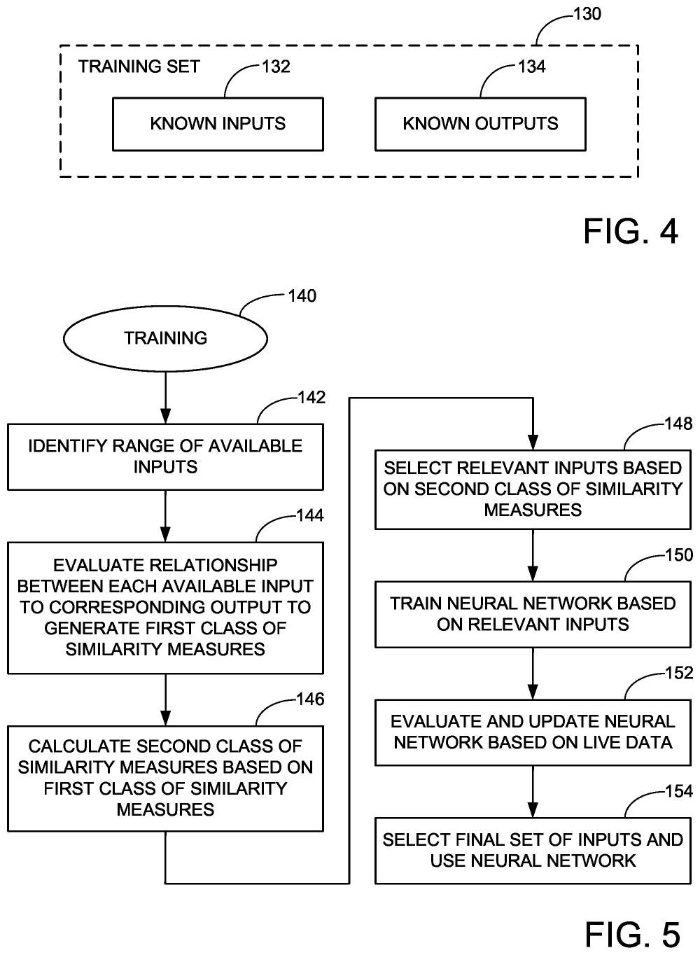

To this end, FIG. 4 depicts a training set 130 used by the module 120. The training set includes a set of known inputs 132 and a set of known outputs 134. The form and size of the respective sets will depend on the application. Using the present example in which the network 100 is being trained to forecast the weather in Berlin, the known outputs 134 could be the actual weather data for Berlin for each day during some previous historical period. The known inputs 132 may be the various data points discussed above that precede those corresponding days.

In another example, let it be assumed that the network is instead trained as an image processor capable of differentiating between images of cats and images of dogs. In this case, the input data 132 may be statistically significant numbers of images of each of these types of animals (and possibly other images that do not include a dog or a cat). The output data 134 would include the labeling of each picture (e.g., image 1 is a dog, image 2 is a cat, image 3 is neither a dog nor a cat, etc.). As before, the front end module 120 is capable of processing these types of data to train the network 100 to differentiate between images of cats and dogs.

FIG. 5 provides a flow chart for a training routine 140 carried out by the module 120 in accordance with some embodiments. The routine may represent programming carried out by a programmable processor in a computer-based environment. Other steps may be performed as required.

At step 142, a range of available inputs is initially identified. This includes identifying the types of available inputs as well as a sufficient amount of data points (e.g., the known inputs 132 from FIG. 4).

At step 144, the relationship between each available input to the associated output (e.g., known outputs 134) is evaluated to generate a first set, or class, of similarity measures. In various embodiments, it is contemplated that the similarity measures will be based on the well-known cosine similarity function, the details of which will be discussed below. However, other forms of similarity measures can be used.

The routine continues at step 146 to next calculate a second set, or class, of similarity measures based on the first class of similarity measures. The second class of similarity measures may be various combinations of the first class of similarity measures using selected functions, examples of which will be discussed below.

The second class of similarity measures are thereafter used at step 148 to select a set of relevant inputs. This selection may be based on those available inputs having the greatest magnitudes of the similarity measures, and therefore have the greatest relevance on the operation of the network. The network is trained at step 150 using the relevant inputs selected at step 148.

As desired, additional processing steps can be carried out as well, such as an evaluation operation at step 152 in which the training of the network is evaluated and changes are made, as required, to refine the set of relevant inputs. A final set of relevant inputs may thereafter be selected and used during normal operation of the network, step 154.

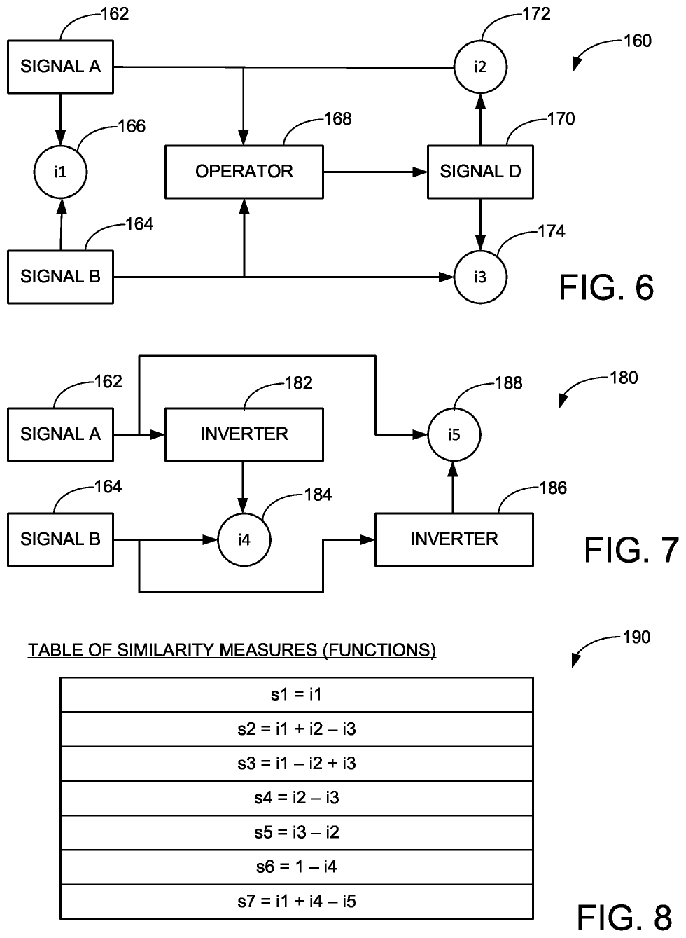

FIGS. 6 through 8 illustrate the manner in which the module 120 operates to generate the various similarity measures used in FIG. 5 in some embodiments. As noted above, one similarity measure that is useful in some embodiments is the cosine similarity function. This function, referred to as CosSim or CS, is determined for an input signal A and a corresponding output signal B, where A and B are arranged as vectors in a high dimensional space:

$$CosSim = CS = \frac{A \cdot B}{‖ A ‖ ‖ B ‖} = \frac{{Σ}_{i = 1}^{n} {A}_{i} {B}_{i}}{\sqrt{{\sum }_{i = 1}^{n} {A}_{i}^{2}} \sqrt{{\sum }_{i - 1}^{n} {B}_{i}^{2}}} \qquad ( 1 )$$

CS is a measure of similarity between two non-zero vectors in an inner product space. It generally represents the cosine of the angle between the respective vectors, which are normalized to an overall magnitude (such as from 0 to 1). Hence, CS is a measure of orientation and not magnitude: two parallel vectors pointing in the same direction would have a similarity of one (CS=1), two orthogonal vectors would have a similarity of zero (CS=0), two parallel vectors pointing in opposite directions would have a similarity of minus-one (CS=−1), and so on. Other similarity measures can be used including but not limited to cosine distance (which is the complement of cosine similarity, e.g., CD=1−CS), Tanimoto coefficients, Otsuka-Ochiai coefficients, or any other suitable measure of vector similarity.

FIG. 6 provides a functional block representation of a calculation circuit 160 of the module 120. Blocks 162 and 164 provide respective pairs of inputs and outputs Ai and Bi, and a summing junction 166 generates a cosine similarity it based on these vectors as follows:

i1=CS(Ai,Bi) (2)

using the formula from equation (1). the result (i1) is referred to as a first similarity measure, and such measures are determined for each combination (set) of available known inputs and corresponding outputs in step 144 in FIG. 5.

Continuing with FIG. 6, additional calculations are provided to generate further similarity measures. This includes an operator block 168 that combines the signals Ai and Bi using some selected function, such as an AND function, etc., to generate a new signal Di (block 170). Substantially any selected function can be used, and different functions can be used in different operator blocks 168 to provide different output signals D′, D″, etc. that can be similarly evaluated. A cosine similarity i2 is generated for Ai and Di using summing junction 172:

i2=CS(Ai,Di) (3)

and a cosine similarity i3 is generated for Bi and Di using summing junction 174:

i3=CS(Bi,Di) (4)

FIG. 7 shows another calculation circuit 180 of the module 120. As before, the ordered pair of signals Ai and Bi are presented at blocks 162, 164. The input signal Ai is inverted (e.g., a logical NOT operation) using an inverter block 182 to generate the inverted signal Ai′. A cosine similarity i4 is generated using Ai′ and Bi at summing junction 184:

i4=CS(Ai′,Bi) (5)

An inverter block 186 inverts the output signal Bi to form an inverted signal Bi′. A cosine similarity i5 is generated using Ai and Bi′ at summing junction 188:

i5=CS(Ai,Bi′) (6)

From FIGS. 6-7 it will be understood that, more generally, similarity measures are calculated for a pair of signals (Ai, Bi) as well as various combinations or modified representations of these signals as desired. Empirical analysis can be used to identify useful combinations and modified representations that tend to provide useful results.

Once these various similarity measures are generated, the module 120 continues by generating a second set, or class, of similarity measures. The second class of similarity measures, also sometimes referred to as similarity scores, are obtained by combining the various similarity measures it through i5 in various ways. In the present example, these scores are identified as s1 through s7. These are summarized in a table 190 shown in FIG. 8 and can be expressed as follows:

s1=i1

s2=i1+i2−i3

s3=i1−i2+i3

s4=i2−i3

s5=i3−i2

s6=1−i4

s7=i1+i4−i5 (7)

As before, other forms of similarity measures (e.g., scores) can be generated, including higher form expressions as desired. From equation (7) and FIG. 8 it will be noted that each of the second similarity measures (scores) s1-s7 are directly or indirectly based on the first similarity measure it (as well as the various additional similarity measures i2-i5).

The various combinations for i1-i5 and s1-s7 have been found to be particularly useful and suitable, but it will be appreciated that other combinations and functions can be used as desired, so these are merely illustrative and not limiting. For reference, at least it is contemplated as incorporated into the first class of similarity measures of step 144 in FIG. 5, and at least s7 is contemplated as incorporated into the second class of similarity measures of step 146 in FIG. 5.

Generally, a higher score in any of these values tends to indicate a higher relevance, and a lower score tends to indicate a lower relevance. The score s1 tends to indicate a general similarity between the input and output signals, while the scores s2-s7 tend to indicate a potential causality between the input and output signals. While all of the scores can be sorted and evaluated, in some embodiments the module 120 operates to focus on the final score s7.

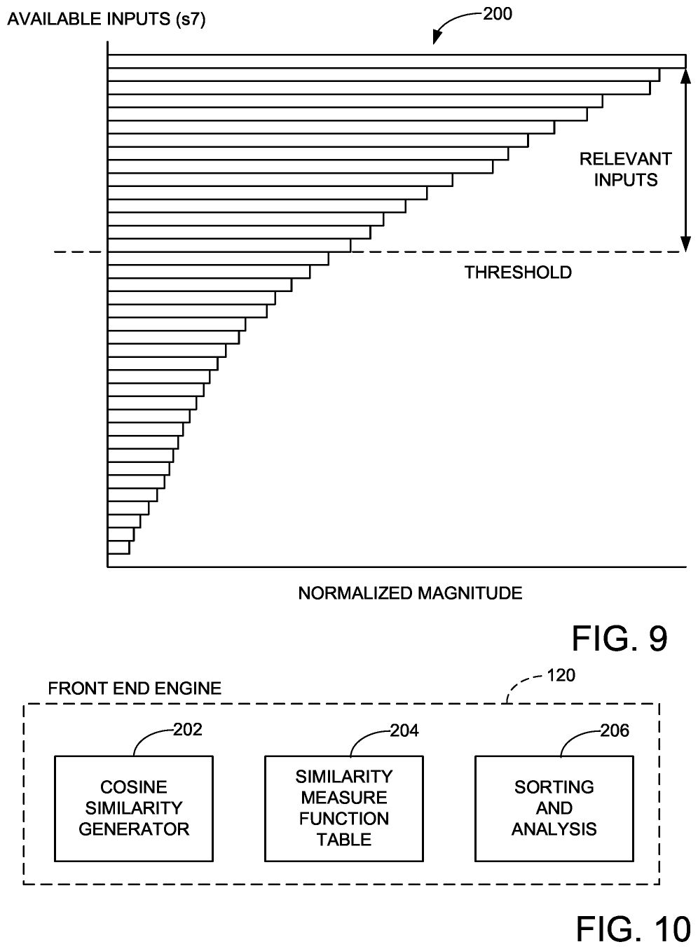

Accordingly, as shown in FIG. 9, the various available inputs can be sorted and ranked for the s7 values, as represented by graphical data 200. It will be understood that the data shown in FIG. 9 is merely illustrative and is not limiting; in practice many thousands or millions of available input data sets may be evaluated and associated measures determined for each.

The relevant inputs are selected as those inputs having the similarity measures (scores) above some selected threshold, as shown in FIG. 9. In one example, several million inputs may be evaluated and the top several thousand with the highest s7 scores may be selected as the relevant inputs. Additional data analysis can be carried out to identify a suitable cut-off point for the threshold. In some cases, some maximum number of available relevant inputs will be selected, such as the top 5000 inputs. In other cases, curve fitting techniques are applied and the threshold cut-off is selected based on some natural behavior of the data. In still other cases, a network with a fixed number of nodes is initially designed or selected, and the threshold is selected based on a suitable number of inputs for this preselected network.

While FIG. 9 shows that the relevant inputs are based on the magnitudes of the s7 score values, other embodiments are contemplated. Combinations of the scores s1-s7 can be used to select the most relevant inputs. For example, a weighted combination value s-total can be generated as follows:

s-total=A(s1)+B(s2)+C(s3)+D(s4)+E(s5)+F(s6)+G(s7) (8)

where the variables A through G in equation (8) are weighted scalar values. In this way, one score such as s7 can be weighted heavily but the contributions, either positively or negatively, from other scores can be incorporated into the final determination as well. The inputs can thus be selected based on a sorted arrangement of the s-total values. Other arrangements are contemplated and will immediately occur to the skilled artisan in view of the present discussion.

FIG. 10 is a functional block representation of the front end module 120 from FIG. 3 in some embodiments. As noted above, the front end module 120 may be realized as one or more programmable processors and/or hardware circuits to perform the various operations described herein (see e.g., CPU 126, memory 128 in FIG. 3). The module 120 includes a cosine similarity generator 202, a similarity measure function table 204 and a sorting and analysis module 206. Other arrangements can be used.

The generator 202 operates as described above to generate the various cosine similarities such as it through i5 (see e.g., FIGS. 6-7). The similarity measure function table 204 maintains the various functions as a data structure and operates to calculate the various measures such as s1 through s7 (see e.g., FIG. 8). The sorting and analysis block 206 evaluates the respective measures to sort and identify the relevant inputs (see e.g., FIG. 9).

Once the relevant inputs have been selected, the network 100 is trained using only the relevant inputs. Effectiveness of the training can be evaluated and adjustments made as necessary, in the manner discussed above.

In further embodiments, the input and/or output signals can be preprocessed prior to evaluation. This can include inverting the input signal or performing a phase shift, delay, convolution, derivation, calculation of an average, median, minimum, maximum, standard deviation, or other processes such as changing resolution, normalization, addition of reverberation, blurring, etc. If it is determined that a distinct processed signal scores higher, that signal can be applied as a potential input to the neural network, or the parameters can be modified further to derive other signals. Redundancies can be identified to reduce, input signals can be combined, etc.

As noted above, an input signal can be substantially any available signal in synchronization with the output signal(s). This can include the output signals of neurons in existing neural networks.

It will be appreciated that the various embodiments presented herein can achieve significantly smaller and faster networks, as the burden for judging the usefulness of signals is offloaded from the network itself and instead handled by the front end. Further, the various embodiments allow an active search for potentially useful signals in all available additional data sources, including sources that might not initially appear to be useful. Because signals can be used from existing neural networks, the learning already achieved by the previous network can be leveraged to enhance or improve the performance of such networks. Detecting the usefulness of inputs can also be used to find useful transformations (e.g., shifting, convolutions, etc.) of an input signal and useful properties (e.g., amount of shifting, size or number of dimensions, etc.). These can also be beneficial in finding the correct resolution or the rounding of values of an input signal.

As discussed previously, artificial neural networks are inspired by a simplification of neurons in a brain, but their similarity or simulation is mainly reduced to their inner function. It will be noted that every neuron in a brain has a distinct location and orientation in space, which is not arbitrary. Neurons are at a meaningful location in the brain and connected to other neurons in a meaningful way. These meaningfulness measures are simulated by the present method by directing the input to the artificial neurons to find the potential relevance through the network.

Further related embodiments can include a method for an autoencoder network, where a bottleneck layer is forced to output binary values rather than continuous numbers. This can be achieved by adding a binarizing component to the loss function of the neural network. This loss function, referred to as the “neckloss,” can be expressed as follows:

neckloss=Σᵢ₌₁ⁿ|0.5−|0.5−oᵢ∥ (9)

where of are the current outputs of the bottleneck layer of size n. The neckloss function penalizes all values which are not either 0 or 1 regarding their distance from 0 or 1 and therefore pushes the weights of the network in the direction to produce either 0 or 1, while the primary loss function forces the network to learn to encode and decode the data. This enables the dimensionally reduced bottleneck of the encoder can be used to compress data while the decoder of the autoencoder learns to decompress it. The output from the bottleneck layer from the encoder can then be taken, rounded to a bit and then transmitted to a receiver where the decoder can restore the original data.

The various embodiments presented above have been implemented in several real-world applications. The following are examples to discuss the effectiveness of the disclosed methodology.

### Example 1

An artificial neural network was trained using a front end processor as described above for data from a well-known review portal. The portal allows consumers to write and post online reviews about recent experiences at various locations. The reviews include the ability of the user to write out text to describe the experience (up to some maximum number of characters), as well as to provide a rating such as from one (1) to five (5) “stars.”

The task was to enable the network to predict whether a written review was (a) useful, (b) entertaining and (c) how many stars were given by the review. The input data involved taking all of the text from existing reviews, splitting the text into phrases of two words (tuplets), and using each tuplet as a separate input signal.

An initial set of 15.5 million input signals were evaluated and distilled down to about 1000 relevant input signals. The relevant input signals were used to train a small network, which was carried out on a standard laptop computer without a separate GPU (graphics processing unit) in about 10 minutes.

The results were surprisingly positive, with AUROC and AUPRC scores each greater than 0.8. For reference, AUROC refers to Area Under the Receiver Operating Characteristic Curve (ROC), and AUPRC refers to Area Under the Precision-Recall Curve (PRC). Each of these are performance metrics that measure the predictive performance of a classifier. For an AUROC score, a value of 1.0 is associated with a perfect model, and a value of 0.5 is associated with a random model. For an AUPRC score, a value of 1.0 is associated with a perfect model and a score of 0 is a random model. Accordingly, respective AUROC and AUPRC scores of above 0.8 is significant, and demonstrates the effectiveness of the training methodology.

In a related experiment, the output from neurons in an existing (first) neural network were evaluated as inputs to a new (second) neural network. The first network was trained as described above to predict the number of stars for a given review. The second network was subsequently trained to predict the usefulness of the reviews based on the output neurons from the first network. This relationship was based on an assumption that the calculations relevant to judge how many stars are provided in a review may also be relevant to the usefulness of the review.

The experiment showed that the second network selected the neuron outputs from the first network as about 10% of the total inputs for the second network. This showed the same good precision and recall (e.g., greater than 0.8) after a short training sequence.

In another related experiment, a third new neural network was denied all access to the original data sources and instead was only allowed to use the output neurons from the first network, thereby letting the third network act entirely as a meta network. This network configuration also showed the same fast start initialization properties as before, although it did not achieve the same accuracy as before (e.g., lower AUROC and AUPRC scores).

### Example 2

An artificial neural network was trained using a well-known commercially available database that listed all known protein chemical formulas, annotated with their associated function(s). The task was to determine whether the network could operate as a predictive model to predict whether an unknown protein has some influence on cholesterol level.

In this example, the number of available input signals comprised approximately 44 million different proteins, and the training was carried out using a 4 GB Tesla K10 GPU commercially available from NVIDIA Corporation. As before, a significantly smaller number of relevant inputs were identified and the training was completed in a relatively short period of time. The resulting model demonstrated good predictive capabilities. This experiment was repeated for brain development, dopamine production and other effects with similar good effects.

A further embodiment of the present disclosure can be described as a “Two Step Content Moderation” operation. In this case, an innovative filter is applied for user-generated text. It determines whether such is appropriate for publication. As platform operators become more and more responsible for their users' content, the process of content moderation is becoming increasingly important. Online “hate speech” is already a hot political issue. In the next few years, forum operators will face even more legal problems or will have to annoy their users with excessive censorship, despite the immense technological or often personnel-intensive effort. Neither do forum providers want to hurt or traumatize their audience with inappropriate content nor do they want to raise issues about censorship by blocking unrelated content.

The Two Step Content Moderation approach offers a solution. It provides a fast, resource-saving classification combined with precise in-depth linguistic analysis. In the first step, postings are examined by an extremely fast FNN network that can determine very accurately whether content is completely harmless.

All postings that turn out to be somehow questionable are then carefully reexamined, understood and evaluated by an extremely complex, but very precise natural language processing model.

Since the majority of the content is not of concern, most postings only pass through the first step. This stage is set to produce as few false negatives as possible on the cost of false positives which are then detected and handled in the second stage. The second filter does an in depth analysis and outputs and provides an exact percentage which reflects the questionability of the content. Here the operator can set how much “edgy” postings he wants to allow, for example 50% in a gamer group where some aggressive comments are allowed or 0% in a safe LGBT forum with a zero tolerance policy.

All together, the Two Step Content Moderation offers an incredibly fast and resources conserving but at the same time very exact content classification. This system can be easily incorporated into the above embodiments.

In conclusion, the various embodiments presented herein provide a number of benefits over the existing art. The system allows networks to be fed with significantly large numbers of input signals, often in the millions or more. This enables neural networks to be generated for really big data sets. The training can be carried out using minimal hardware, such as small microcontrollers, the Internet of Things, etc. Networks can be trained independently of cloud networks, enhancing privacy and data protection as the training is carried out locally. Short running time requirements makes it possible to deploy rapid learning networks, which can be particularly useful in changing environments. Another advantage is the ability to use existing trained networks as selective inputs to new networks. This allows multiple smaller networks to build on other networks instead of requiring large, monolithic networks. Further embodiments can utilize the Two Step Content Moderation system to further enhance system effectiveness.

Even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method for training an artificial neural network, comprising:
identifying a set of possible inputs to the artificial neural network;
generating, for each of the possible inputs, a first similarity measure between the possible input and a known output relevant to a task for which the artificial neural network is to be trained;
generating a second similarity measure based on the first similarity measure;
selecting a set of relevant inputs from the set of possible inputs based on the second similarity measure; and
training the artificial neural network using the set of relevant inputs without using the remaining set of possible inputs.

2. The method of claim 1, further comprising evaluating operation of the artificial neural network using the set of relevant inputs, adjusting the set of relevant inputs to exclude at least one of the relevant inputs and to add at least one additional input to form a final set of relevant inputs, and operating the artificial neural network using the final set of relevant inputs.

3. The method of claim 1, wherein the first similarity measure S1 is a cosine similarity between an input signal A and an output signal B.

4. The method of claim 3, wherein the second similarity measure S2 is based on the first similarity measure S1 in combination with a second cosine similarity between the input signal A and a signal D based on signals A and B.

5. The method of claim 1, further comprising generating a set of similarity measures comprising different combinations of the first and second similarity measures, and using the set of similarity measures to select the set of relevant inputs.

6. The method of claim 1, wherein the training set is carried out using a training set comprising a first set of known inputs and a first set of known outputs.

7. The method of claim 1, further comprising generating a normalized magnitude for effectiveness of each of possible inputs, sorting the normalized magnitudes in decreasing order, identifying a threshold cut-off value, and using all of the possible inputs above the threshold cut-off value as the set of relevant inputs.

8. The method of claim 1, further comprising using respective cosine similarity functions to generate each of the first similarity measure, the second similarity measure, and each of a plurality of additional similarity measures based on respective elements in the set of possible inputs, wherein the second similarity measure and each of the plurality of additional similarity measures are utilized to select the set of relevant inputs.

9. An apparatus, comprising:
an artificial neural network logic circuit comprising a plurality of input nodes, a plurality of output nodes and a plurality of intervening hidden nodes between the input nodes and the output nodes; and
a front end logic circuit configured to train the artificial neural network logic circuit comprising a processing circuit configured to:
use a cosine similarity function to generate, for each of a plurality of possible inputs, a first similarity measure between the possible input and a known output relevant to a task for which the artificial neural network logic circuit is to be trained;
derive a second similarity measure based on the first similarity measure;
select a set of relevant inputs from the set of possible inputs based on the second similarity measure; and
forward the set of relevant inputs to the neural net while restricting passage of a remaining set of possible inputs to the artificial neural network logic circuit to train the artificial neural network logic circuit.

10. The apparatus of claim 9, wherein the processing circuit of the front end logic circuit uses a cosine similarity function to generate the second similarity measure for each of the possible inputs.

11. The apparatus of claim 9, wherein the first similarity measure is based on a combination of at least two of the plurality of possible inputs, and wherein the second similarity measure corresponds to at least one of the at least two of the plurality of possible inputs.

12. The apparatus of claim 9, wherein the second similarity measure is selected based on a magnitude of the first similarity measure.

13. The apparatus of claim 9, wherein a set of similarity measures are generated based on the first similarity measure, wherein:
the first similarity measure is characterized as S1 and comprises a first cosine similarity it between an input signal A and an output signal B;
the second similarity measure is characterized as S2 and comprises a combination of the first cosine similarity i1, a second cosine similarity between the input signal A and a modified signal D and a third cosine similarity between the output signal B and the modified signal D, the modified signal D based on the input signal A and the output signal B.

14. The apparatus of claim 13, wherein the set of similarity measures includes at least a third, fourth fifth, sixth and seventh similarity measure, each based on a cosine similarity function and on at least one other of the other similarity measures.

15. The apparatus of claim 9, wherein the front end logic circuit comprises a cosine similarity generator comprising at least one programmable processor configured to calculate various cosine similarity values between respective inputs, a similarity measure function table in memory configured to list the associated similarity measure values determined by the cosine similarity generator, and a sorting and analysis circuit comprising at least one programmable processor configured to sort, by magnitude, a combined similarity measure based on the first and second similarity measures.

16. A front end logic circuit configured to train an artificial neural network, the front end logic circuit comprising at least one processing circuit configured to use a cosine similarity function to generate, for each of a plurality of possible inputs, a first similarity measure between the possible input and a known output relevant to a task for which the artificial neural network logic circuit is to be trained, to derive a second similarity measure based on the first similarity measure, to select a set of relevant inputs from the set of possible inputs based on the second similarity measure; and to forward the set of relevant inputs to the neural net while restricting passage of a remaining set of possible inputs to the artificial neural network logic circuit to train the artificial neural network logic circuit.

17. The front end logic circuit of claim 16, wherein the at least one processing circuit comprises one or more programmable processors and associated memory to store program instructions executed thereby.

18. The front end logic circuit of claim 16, wherein the at least one processing circuit comprises a hardware based logic circuit.

19. The front end logic circuit of claim 16, wherein the processing circuit comprises a cosine similarity generator configured to calculate various cosine similarity values between respective inputs, and a sorting and analysis circuit configured to sort, by magnitude, a combined similarity measure based on the first and second similarity measures stored in an associated memory, the sorting and analysis circuit selecting the set of relevant inputs responsive to a predetermined threshold.

20. The front end logic circuit of claim 16, wherein each of a population of similarity measures, including the second similarity measure, are determined by the at least one processing circuit using respective cosine similarity functions.
